(19) United States
(12) Patent Application Publication
(10) Pub. No.: US 2006/0226585 A1
(43) Pub. Date: Oct. 12, 2006

(54) Air spring suspension system

(76) Inventor: David A. Drain, Taylor, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/100,666

(22) Filed: Apr. 7, 2005

(51) Int. Cl. F16F 9/04

(52) U.S. Cl. 267/64.27

(57) ABSTRACT

An air spring suspension system includes at least one air spring having a heat affected zone in proximity to at least one heat radiating component in a vehicle. At least one heat insulating member is established on at least a portion of the air spring. The heat insulating member is adapted to reduce the surface temperature of the air spring in the heat affected zone.

### TECHNICAL FIELD

The present disclosure relates generally to vehicle suspension systems, and more particularly to air spring suspension systems.

### BACKGROUND

Under certain conditions, the exhaust system of a vehicle having an internal combustion engine may attain relatively high temperatures. Vehicle packaging considerations may lead vehicle designers to route the exhaust system within relatively close proximity to the spring member of the vehicle suspension system. Vehicle designers may also find it desirable to use air springs as the spring members of the vehicle suspension system. Unless countermeasures are taken, an exhaust system at relatively high temperatures may transmit heat energy to a nearby air spring and cause the air spring to undesirably experience localized temperatures beyond recommended design guidelines. To isolate the air spring from the exhaust heat effects, some attempts have included use of a rigid heat shield formed from metal or heat resistant plastic. Heat resistant fabrics have also been used for similar purposes. These existing heat shields/fabrics are attached to the exhaust system, body, or other rigid underbody components so as to reduce heat transfer between the exhaust system and the air spring. Rigid shields and heat resistant fabrics may suffer from various drawbacks, including packaging, attachment, noise, and durability issues, which issues may generally take considerable effort to overcome for each new vehicle.

Thus, it would be desirable to provide a heat shield for an air spring in a suspension system that overcomes these drawbacks while providing an adequate thermal barrier for the air spring in a cost effective manner.

### SUMMARY

An air spring suspension system includes at least one air spring having a heat affected zone in proximity to at least one heat radiating component in a vehicle. At least one heat insulating member is established on at least a portion of the air spring. The heat insulating member is adapted to reduce the surface temperature of the air spring in the heat affected zone.

### BRIEF DESCRIPTION OF THE DRAWINGS

Objects, features and advantages of embodiments of the present disclosure may become apparent by reference to the following detailed description and drawings, in which like reference numerals correspond to similar, though not necessarily identical components. For the sake of brevity, reference numerals having a previously described function may not necessarily be described in connection with other drawings in which they appear.

FIG. 1 is a schematic, bottom plan view of a motor vehicle incorporating the air spring suspension system as described herein;

FIG. 2 is an enlarged, exploded, cutaway perspective view of an air spring with a heat insulating member;

FIG. 3 is an enlarged perspective view showing an alternate embodiment of the heat insulating member; and

FIG. 4 is an enlarged perspective view showing a further alternate embodiment of the heat insulating member.

### DETAILED DESCRIPTION OF THE EMBODIMENTS

The present inventor has unexpectedly and fortuitously discovered a heat shield as disclosed herein for an air spring in a suspension system that advantageously, substantially overcomes the drawbacks mentioned above while providing a substantially adequate thermal barrier for the air spring in a cost effective manner.

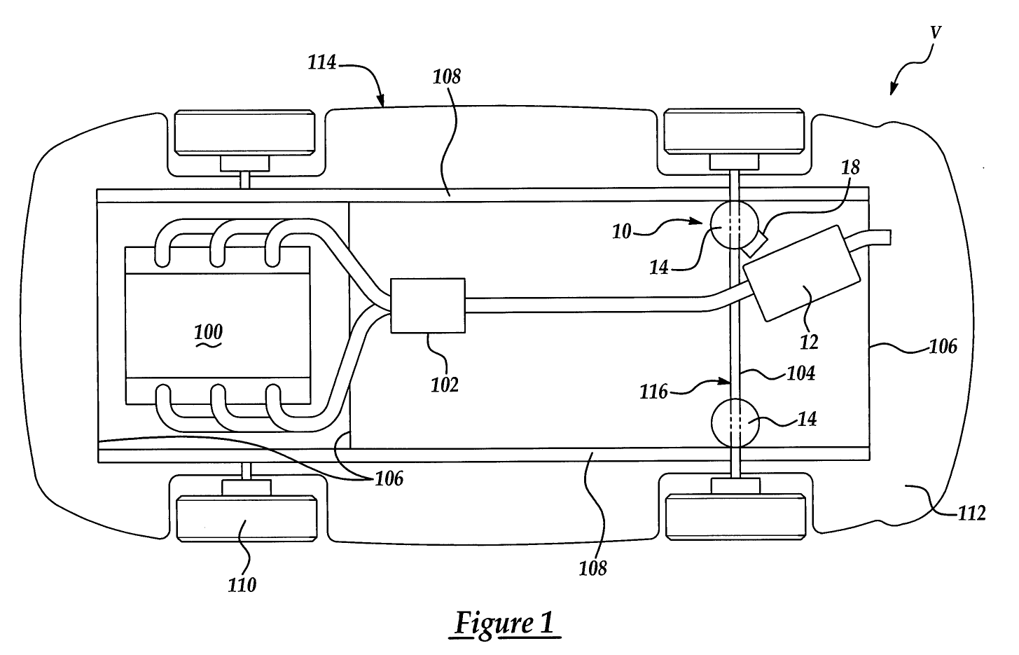

Referring now to FIG. 1, a schematic representation is shown of the underside of a motor vehicle V (a non-limitative example of which is a sport utility vehicle (SUV), pick-up truck, other passenger/cargo vehicles, or the like). The motor vehicle V generally includes an engine 100, such as an internal combustion engine, a catalytic converter 102, an axle 104, cross members 106, frame siderails 108, wheels 110, and a body 112. The sprung mass (for example, the body 112 and anything else suspended by the suspension system) is designated generally at 114. The unsprung mass (for example, the axle 104, wheels 110 and the like) is designated generally at 116.

An air spring suspension system is designated generally as 10. The vehicle V has at least one heat radiating component 12. An exhaust system is depicted as the heat radiating component 12, though it is to be understood that there may be other heat radiating components 12 other than exhaust systems. Some non-limitative examples of other possible heat radiating components 12 of the vehicle V that could be packaged close to the air spring 14 include the engine 100, the transmission and axle 104, and the brake system.

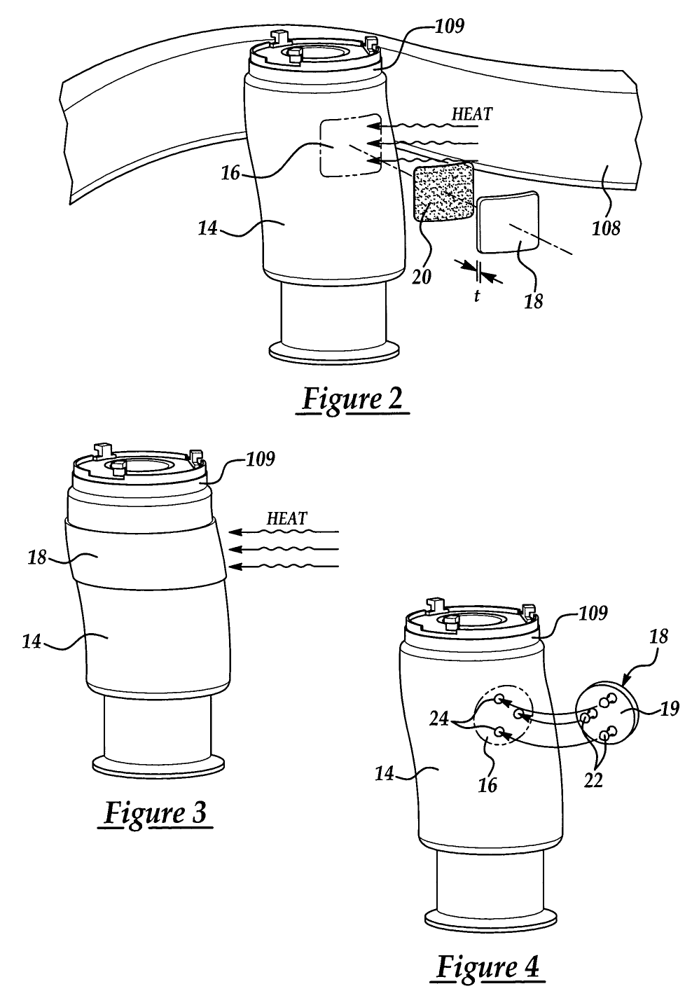

Referring also to FIG. 2, the air spring suspension system 10 includes at least one air spring/airbag 14 having a heat affected zone 16 on the air spring 14 body and in proximity to the heat radiating component 12. It is to be understood that the air spring(s) 14 are attached to the suspension system 10 by any suitable means. In an embodiment, the air springs 14 are operatively mounted to the frame of the vehicle V via mounting bracket 109. As depicted in FIGS. 1 and 2, the mounting bracket 109 is integrally formed with and/or welded or otherwise suitably attached to frame siderail 108.

In an embodiment, at least one heat insulating member 18 is established on at least a portion of the air spring 14. The heat insulating member 18 is adapted to reduce a surface temperature of the air spring(s) 14 in the heat affected zone 16. As defined herein, “established on” is meant to include direct contact between heat insulating member 18 and air spring 14, as well as indirect contact, e.g. space and/or other layer(s) between heat insulating member 18 and air spring 14.

It is to be understood that the heat insulating member 18 may be of any suitable size, shape and configuration, as desired. Further, there may be any number of heat insulating members 18, as desired. The heat affected zone/heat profile 16 may also be of any size, shape or configuration. In one embodiment, the heat insulating member 18 is formed to substantially completely cover heat affected zone 16, though it is contemplated as being within the purview of this disclosure that heat insulating member 18 may advantageously provide adequate heat insulating properties when covering more or less than the heat affected zone 16.

Heat insulating member 18 may be formed from any non-metal material suitable to adequately insulate the air spring(s) 14 from undesirable heating in predetermined area(s) (for example, generally in the area of heat affected zone 16). In an embodiment, heat insulating member 18 is formed from a suitable, flexible or very flexible, polymeric material adapted for use in relatively high temperature applications. A non-limitative example of such a polymeric material includes high temperature silicone materials (examples of which include but are not limited to phenyl methyl silicones, silicone elastomer materials, and/or combinations thereof). As defined herein, flexible is meant to mean materials which generally retain their shape in the absence of applied pressure, but are relatively easily deformable by hand; and very flexible is meant to mean materials which generally do not retain their shape in the absence of applied pressure.

Some alternate suitable shapes for heat insulating member 18 include, but are not limited to the shapes as depicted in FIGS. 3 and 4 (a band-like shape surrounding air spring 14, and a circular shape, respectively).

Although, as mentioned above, heat insulating member 18 may be of any suitable size, in an embodiment, heat insulating member 18 may have a length or diameter ranging from about 5 cm to about 10 cm; and a width ranging from about 5 cm to about 10 cm. It is to be understood that the heat insulating member 18 may have any suitable thickness, designated “t” in FIG. 2; however, in an embodiment, the thickness t of heat insulating member 18 ranges between about 1 mm and about 10 mm; in an alternate embodiment, thickness t ranges between about 2 mm and about 3 mm. The thickness of heat insulating member 18 is exaggerated as shown in FIG. 1 for illustrative purposes.

It is to be understood that heat insulating member 18 may be attached to air spring 14 by any suitable means. In an embodiment, heat insulating member 18 is adhesively bonded to at least a portion of the air spring(s) 14, as shown in FIG. 2. An adhesive layer 20 may be disposed on air spring 14 and/or on the air spring-engaging surface 19 of heat insulating member 18. Further, in an alternate embodiment, adhesive layer 20 may be one component of an adhesive which is not activated until intimate contact with the other component of the adhesive. For example, one component of adhesive may be disposed on the air spring-engaging surface 19 of heat insulating member 18, and the other component of the adhesive may be disposed on the air spring 14, or vice versa. The air spring 14 may be formed substantially entirely of one or the other component of the adhesive; or the one or other component may be, or may be disposed on, at least a portion of the heat affected zone 16.

In one embodiment, the heat insulating member 18 is adhesively bonded to at least a portion of the air spring 14 by a cold patch, similar to a cold tire patch.

In a further embodiment, depending upon the materials used to form air spring 14 and heat insulating member 18, the heat insulating member 18 may be attached/adhered/formed with air spring 14 during processing and/or formation of air spring 14.

In an alternate embodiment, the heat insulating member 18 is mechanically attached, directly or indirectly, to at least a portion of the air spring 14. It is to be understood that such mechanical attachment may be any suitable attachment. One non-limitative example of such a mechanical attachment, as depicted in FIG. 3, is the frictional engagement of the band configuration of heat insulating member 18 around air spring 14. Another non-limitative example of such a mechanical attachment, as depicted in FIG. 4, includes one or more bosses 22 extending substantially outwardly from the air spring-engaging surface 19 of heat insulating member 18. The boss(es) 22 are operatively matingly engageable with boss-receiving aperture(s) 24 defined in air spring 14. Bosses 22 may be formed from any suitable material. In an embodiment, bosses 22 are formed from substantially the same material, or a material substantially similar to that from which heat insulating member 18 is formed.

Boss(es) 22, or any other suitable protruding member, may also be configured as stand-offs, if desired. In this alternate embodiment, the necked-down shaft portion of boss(es) 22 are not received within boss-receiving aperture(s) 24, but rather serve to space heat insulating member 18 a predetermined distance from air spring 14. As such, heat insulating member 18 does not directly contact air spring 14, but rather casts a heat insulating shadow on at least a portion of air spring 14, for example on at least a portion of heat affected zone 16. In still a further alternate embodiment, heat insulating member 18 may be spaced the predetermined distance away from air spring 14 by being attached to a vehicle V component adjacent air spring 14 (for example, a part of the suspension 10 other than the air spring 14) so as to cast the heat insulating shadow as described immediately above. This predetermined distance from air spring 14 to heat insulating member 18 may be any suitable distance, however, in an embodiment, this distance may range from about 2 mm to about 5 cm.

It is to be understood that adhesives 20 may also be used with mechanical attachments, if desired.

In an embodiment, the operating temperature to which the air spring(s) 14 are exposed may range as high as between about 96° C. and about 125° C. Without being bound to any theory, it is expected that at least the heat affected zone 16 of air spring 14 would advantageously experience a temperature reduction ranging between about 20° C. and about 30° C. through use of embodiment(s) of the heat insulating member 18 as disclosed herein.

The air spring(s)/airbags 14 may be made from any suitable material. In an embodiment, air springs 14 are formed from a suitable flexible material, such as a rubber material. One non-limitative example of a suitable rubber material is ethylene propylene diene monomer (EPDM) rubber.

Further, it is to be understood that it is within the purview of the present disclosure to form the air spring 14, or at least the heat affected zone 16 portion thereof, from one of the materials mentioned above in relation to the materials forming the heat insulating member 18 that are suitable for use in high temperature applications. In this embodiment, it would not be necessary to use a separate heat insulating member 18 (though it 18 could additionally be used in this embodiment, if desired), as the air spring 14 itself could withstand being exposed to higher temperature environments. Although it may, in some instances, generally be more expensive to form the air spring 14 or at least the heat affected zone 16 portion thereof from, e.g. high temperature silicone materials, this embodiment may be desirable for certain applications.

Embodiment(s) of the present disclosure may be used with motor vehicles V having independent rear suspension, front wheel drive, rear wheel drive, etc. Further, embodiments of the present disclosure may be used with motor vehicles V having subframes, unibody construction, etc. Further, a hybrid, electric, or fuel cell vehicle may have high temperature components that may be placed in proximity to an air suspension system, and embodiment(s) of the present disclosure may be used in these vehicles. Yet further, specialty vehicles may have auxiliary power units, refrigeration systems, pumps, or other heat generating systems that may be placed in proximity to an air suspension system, and embodiment(s) of the present disclosure may also be used in these vehicles.

While several embodiments have been described in detail, it will be apparent to those skilled in the art that the disclosed embodiments may be modified. Therefore, the foregoing description is to be considered exemplary rather than limiting.

1. An air spring suspension system for a vehicle having at least one heat radiating component, the air spring suspension system comprising:
at least one air spring having a heat affected zone in proximity to the at least one heat radiating component; and
at least one heat insulating member established on at least a portion of the at least one air spring, the heat insulating member adapted to reduce a surface temperature of the at least one air spring in the heat affected zone.

2. The air spring suspension system as defined in claim 1 wherein the at least one heat insulating member is formed from a polymeric material.

3. The air spring suspension system as defined in claim 2 wherein the polymeric material comprises high temperature silicone materials.

4. The air spring suspension system as defined in claim 3 wherein the high temperature silicone materials comprise at least one of phenyl methyl silicones, silicone elastomer materials, and combinations thereof.

5. The air spring suspension system as defined in claim 1 wherein the at least one heat insulating member is adhesively bonded to the at least a portion of the at least one air spring.

6. The air spring suspension system as defined in claim 5 wherein the adhesive bond is a cold patch.

7. The air spring suspension system as defined in claim 1 wherein the at least one heat insulating member is mechanically attached to the at least a portion of the at least one air spring.

8. The air spring suspension system as defined in claim 7 wherein the at least one heat insulating member substantially surrounds the at least one air spring.

9. The air spring suspension system as defined in claim 7 wherein the at least one heat insulating member is matingly engaged with the at least one air spring.

10. The air spring suspension system as defined in claim 1, further comprising at least one stand off operatively disposed between the at least one heat insulating member and the at least one air spring, the stand off spacing the at least one heat insulating member a predetermined distance from the at least one air spring.

11. The air spring suspension system as defined in claim 1 wherein the surface temperature reduction ranges from about 20° C. to about 30° C.

12. The air spring suspension system as defined in claim 1, further comprising a plurality of heat insulating members.

13. An air spring for a vehicle having at least one heat radiating component, the air spring comprising:
a body having a heat affected zone adapted to be in proximity to the at least one heat radiating component, the body adapted to be exposed to temperatures up to about 125° C.; and
at least one polymeric heat insulating member established on at least a portion of the air spring body, the heat insulating member adapted to reduce a surface temperature of the air spring body in the heat affected zone.

14. The air spring as defined in claim 13 wherein the at least one heat insulating member is adhesively bonded to the at least a portion of the at least one air spring, and wherein the adhesive bond is a cold patch.

15. The air spring as defined in claim 13 wherein the polymeric heat insulating member is formed from at least one of phenyl methyl silicones, silicone elastomer materials, and combinations thereof.

16. The air spring as defined in claim 13 wherein the at least one heat insulating member substantially surrounds the air spring body.

17. The air spring as defined in claim 13 wherein the at least one heat insulating member is matingly engaged with the air spring body.

18. The air spring as defined in claim 13, further comprising at least one stand off operatively disposed between the at least one heat insulating member and the air spring body, the stand off spacing the at least one heat insulating member a predetermined distance from the air spring body.

19. The air spring as defined in claim 13 wherein the surface temperature reduction ranges from about 20° C. to about 30° C.

20. An air spring suspension system for a vehicle having at least one heat radiating component, the air spring suspension system comprising:
at least one air spring formed from a polymeric material adapted for use in environments exhibiting temperatures up to about 125° C.; and
a heat affected zone defined on the at least one air spring, in proximity to the at least one heat radiating component;
wherein the polymeric material substantially prevents the at least one air spring from overheating in the heat affected zone.
